(19) United States
(12) Patent Application Publication
(10) Pub. No.: US 2010/0042429 A1
(43) Pub. Date: Feb. 18, 2010

(54) SYSTEM AND METHOD FOR PROVIDING LOCALLY ADAPTIVE DECISION SUPPORT

(75) Inventor: Shailja Dixit, Waukesha, WI (US)

Correspondence Address: Andrus, Sceales, Starke & Sawall, LLP, 100 East Wisconsin Avenue, Suite 1100, Milwaukee, WI, 53202-4178, US

(73) Assignee: THE GENERAL ELECTRIC COMPANY, Schenectady, NY (US)

(21) Appl. No.: 12/190,693

(22) Filed: Aug. 13, 2008

(51) Int. Cl. G06Q 50/00

(52) U.S. Cl. 705/2

(57) ABSTRACT

A system and method for providing adaptive decision support is disclosed in further detail herein. An embodiment of this system includes a local outcome report that documents a medical outcome, a difference engine that compares the local outcome report to a national outcome report and generates a localized rule, and a rule engine that receives patient data and applies the localized rule from the difference engine to the patient data to produce a prescribed treatment. An embodiment of the method disclosed herein begins with receiving local patient data and outcome data. The outcome data is compared to national outcome data and a local rule is generated from the comparison. Next, the local patient and the outcome data is analyzed and a standard rule is generated based upon this analysis. The standard rule and the local rule are then applied to the local patient data to generate a prescribed treatment.

### BACKGROUND

The present disclosure relates to automated decision support systems. More specifically, the present disclosure relates to the provision of adaptive decision support targeting atypical patient populations.

In today's automated hospitals, physicians use electronic medical records (EMR) for entering and retrieving patients' medical information. The electronic medical records are the digital equivalent of what was previously a patient's paper file. EMRs present the advantages of requiring no physical space for storage and are easily transferred between healthcare institutions, thus being able to follow the patient between a plurality of healthcare providers.

Another advantage of EMRs and a healthcare provider's health records system is that the health records system may include the processors and algorithms necessary to present evidence based clinical guidelines to physicians, based upon the patient's medical information stored in the EMR. The evidence based clinical guidelines used in these health records systems are generalized for identifying and treating conditions across a national population. Therefore, the clinical recommendations received from such health records systems is usually not specific to an individual patient.

When a clinically recommended course of action is not specifically targeted to a patient, the effectiveness of the recommended course of action may be limited and the patient may fail to adhere to the physician's recommended care plan. While an experienced physician may be familiar with local or regional populations, and hence the increased risk for certain pathologies in those populations, ever and more rapidly changing local demographics limit the effectiveness of this experience. Therefore, it is important to provide a system for clinical recommendations that is adaptive to the local and demographic characteristics of the patient in order to tailor a clinical recommendation to each patient's specific needs.

### BRIEF DISCLOSURE

A system for providing adaptive decision support is disclosed in further detail herein. An embodiment of the system includes a database including a patient electronic medical record. A local outcome report documents an outcome associated with the patient electronic medical record. A difference engine receives the local outcome report and compares it to a national outcome report, identifies a divergent between the local outcome report and national outcome report and generates a localized rule. A rule engine receives the patient electronic medical record from the database and receives the localized rule from the difference engine. The rule engine applies a standardized rule and the localized rule to the patient electronic medical record to produce a prescribed treatment.

An alternative embodiment of the disclosed system for providing adaptive decision support includes a database comprising a patient electronic medical record. A general outcome report identifies an average outcome. A local outcome report documents an outcome associated with the patient electronic medical record. A difference engine receives the local outcome report and compares it to the general outcome report and identifies a divergence between the local outcome report and the general outcome report. The difference engine generates a localized rule that reflects the identified divergence. A rules engine receives the patient electronic medical record from the database, receives the localized rule from the difference engine, and receives a standardized rule from a rule source. The rules engine applies the standardized rule and the localized rule to the patient electronic medical record to produce a prescribed treatment.

Embodiments of a method of providing adaptive decision support are also disclosed herein. Embodiments of the method may include the step of receiving local patient data and local outcome data. Next the local outcome data is compared to the national outcome data. Then a local rule is generated from the comparison of the local outcome data to the national outcome data. Next the local patient data and the local outcome data is analyzed and a standard rule is generated based upon this analysis. Next, the standard rule and the local rule are applied to the local patient data. Finally a prescribed treatment is generated.

### BRIEF DESCRIPTION OF THE DRAWINGS

FIG. 1 is a system diagram depicting an embodiment of a system for providing locally adaptive decision support;

FIG. 2 is a system diagram depicting an embodiment of a system for providing adaptive decision support; and

FIG. 3 is a flow chart depicting the steps of an embodiment of a method of providing adaptive decision support.

### DETAILED DISCLOSURE

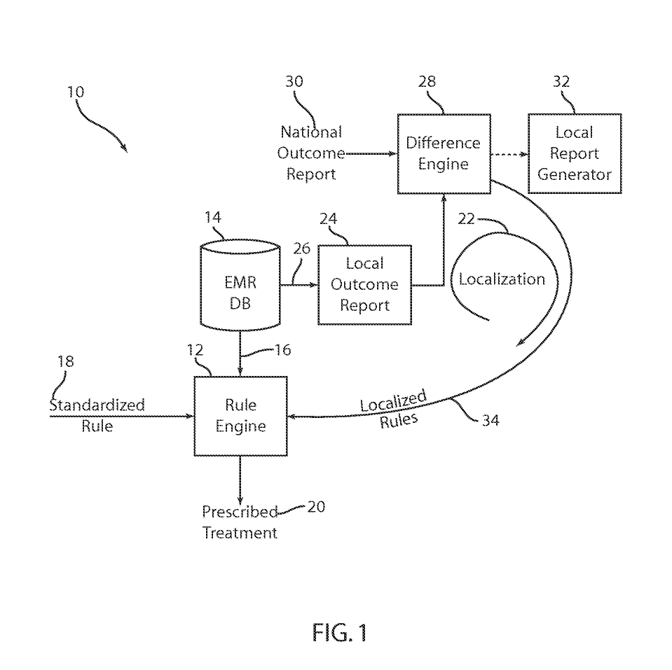

FIG. 1 depicts an embodiment of an adaptive decision support system 10. While this embodiment of the adaptive decision support system 10 is configured to provide medical decision support, those skilled in the art would understand that the presently disclosed system may be modified and applied to other fields and/or challenges in which an adaptive decision response is desired that is adaptive to localized changes.

The adaptive decision support system 10 includes a rule engine 12. The rule engine 12 may be implemented as one or more algorithms or computer programs programmed to control a general computing computer or other microprocessor to process data as disclosed in greater detail herein. The rule engine 12 is in communicative connection with an electronic medical record (EMR) database 14. The EMR database 14 is populated with a plurality of patient electronic medical records. Each patient electronic medical record (EMR) may include a wide variety of patient electronic medical data. The electronic medical data associated with each of the EMRs may include, but is merely exemplary, patient symptom information, lab test results, a patient's medical history, the patient's demographics, including sex and/or ethnicity, basic health information, including height, weight, age, current diagnosis, pre-existing conditions, currently prescribed medication, insurance information and/or other identifying patient information.

The rule engine 12 is provided with medical data 16 for a patient from the EMR database 14. The rule engine 12 also receives one or more standardized rules 18. The rule engine 12 applies the one or more standardized rules 18 to the received medical data 16. The standardized rules 18 may include one or more algorithms that are used by the rule engine 12 to analyze the medical data 16 in order to provide decision support to a clinician. The standardized rules 18 may comprise logic that weights and/or combines the existence or non-existence of particular characteristics or features in the medical data 16 in order to interpret the medical data 16. As a result of the application of the one or more standardized rules 18 to the medical data 16 by the rule engine 12, a prescribed treatment 20 is produced and displayed to a clinician. Thus, the clinician is provided with decision support regarding the medical data.

However, the system just described is susceptible to providing inaccurate decision support in the event of a localized outbreak of an uncommon pathology or disease. In these situations, the standardized rules 18 may not include the proper weighting or logic as should be applied to the population within a localized area. Thus, a localization loop 22 provides an adaptive component to the decision support system 10 that allows for the rule engine 12 to provide more accurate decision support to a local population.

The localization loop 22 includes a local outcome report 24 that is created from de-identified medical data 26. The de-identified medical data is medical data that does not include any identifying information, for example, as in accordance with HIPAA standards. The de-identified medical data 26 includes an indication of the outcome of the treatment of the patient. The de-identified medical data 26 also includes at least some of the medical data that may be provided to the rule engine 12 in order to determine a prescribed treatment 20. The local outcome report 24 includes both the outcome of a medical condition (i.e. final diagnosis, treatment and/or result) as well as the generalized patient data that may or may not be correlated to the outcome. The local outcome report 24 may be generated with outcome data created retrospectively after a patient has been treated. Therefore, it should be understood that while a local outcome report 24 may be generated that includes the outcome data from the patient at some point, the patient's own outcome data may not be included in the local outcome report 24 used in generating a prescribed treatment for that patient as disclosed herein.

The local outcome report 24 is provided to a difference engine 28. The difference engine 28 also receives at least one national outcome report 30. The at least one national outcome report 30 includes an identification of the probabilities of particular medical condition outcomes, as well as the symptoms and/or basis for determining the outcome. Additionally, the national outcome report 30 may include information regarding prescribed treatments and the levels of success associated with the treatments.

The difference engine 28 compares the local outcome report 24 to the national outcome report 30 to identify any discrepancies between the local outcome report 24 and the standard expected outcomes and successful treatments as determined by the national outcome report 30. Therefore, the difference engine 28 identifies the divergences between the local outcome report 24 and the national outcome report 30. These areas of divergence may help to identify a particular condition or pathology that is more common or likely to be found in the local population than is to be expected in the national population as identified by the national outcome report 30. Since the standardized rules 18 presumably reflect a national population, rather than the nuances of the local population, the difference engine 28 produces localized rules 34 that supplement the standardized rules 18 to provide a decision support system 10 that is more sensitive to diagnosing the local population.

The analysis performed by the difference engine 28 may be used to create localized rules 34 that change the weighting of the medical data by the rules engine 12 to identify particular localized pathological or contaminant threats that are experienced more by the local population than the national population. Such localized threats may include pathological threats such as an outbreak of infections with the E. coli bacteria. In an example, a doctor may not identify the E. coli infection as being such, or the standard rules 18 may point to a different medical condition and prescribed treatment 20. If a localized rule 34 is in place from the difference engine 28 identifying that there has recently been an outbreak in E. coli infections in the local area, then the analysis in the rule engine 12 may be more likely to identify the medical condition as that of an E. coli infection and present the prescribed treatment 20 for an E. coli infection. The same may be true for particular viral infections, or specific strains of viruses such as Influenza that may be infecting the local population. Such an identification of the specific viral strain may lead to different prescribed treatment 20 that more effectively targets the specific virus causing the infection in that region, as opposed to a more general standard prescribed treatment as applied to the national population. Additionally, certain local areas may have environmental considerations that may effect or exacerbate particular medical conditions experienced by patients. Specific level environmental conditions, such as pollution, radiation, radium, lead, or pesticide exposure may be apparent from the local outcome reports 24 and thus be the basis of one or more localized rules 34 such that the increased risks associated with these local environmental conditions may be incorporated into the application of the standardized rules 18 in developing the prescribed treatment 20.

The difference engine 28 may further be connected to a local report generator 32. The local report generator may create a report that identifies the differences between the local outcomes and the national outcomes. The local report generator 32 may be a graphical display that presents the local report to a clinician, alternatively the local report generator 32 may present the local report using various electronic communication platforms such as email, SMS messaging, or the Internet. Thus, this local-national comparison may provide a more responsive identification of increased risks affecting a local population. The difference engine 28 may be supplied with local outcome reports from a plurality of medical institutions within a local area. The resulting sharing of the local outcome information in comparison to national standards may help to identify a local population risk, even in instances where each medical institution may only be seeing a limited number of these cases.

The local-national comparison provided by the localization loop 22 helps to identify specific medical challenges facing the local population. These medical conditions may include environmental, hereditary, or societal conditions that may have a profound effect on the diagnosing and treatment of the patient's within the localized area. For example, local culture and society may effect a patient's diet and exercise regimen, or a local population may exhibit an aversion to standard western medical treatment, including drug therapies. The comparison of the local outcome reports to the national outcome reports help to identify these other characteristics of the local population and thus the prescribed treatment 20 generated by the rule engine 12 applying the localized rules 34 to each patient's particular case.

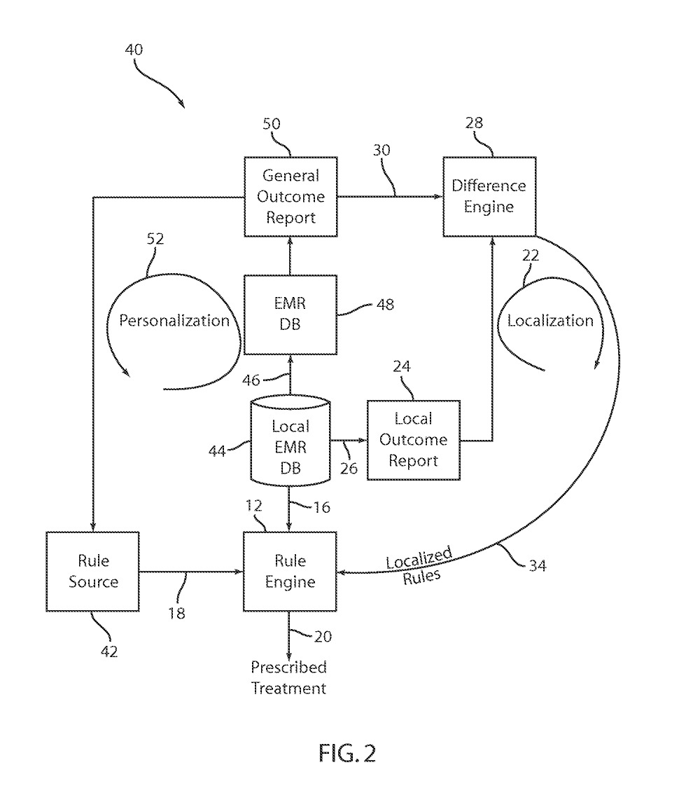

FIG. 2 depicts an alternative embodiment of an adaptive decision support system 40. In FIG. 2, it should be noted that like elements between FIGS. 1 and 2 are indicated with the same reference numerals. The adaptive decision support system 40 includes a rule source 42. The rule source 42 may actually comprise a number of sources of decision support rules or the rule source 42 may be the combination of a plurality of elements that lead to decision support rules. The rule source 42 can include national or international associations that develop guidelines or treatment procedures based upon evidence found in various studies of the subject matter. These guidelines or prescribed treatments are encoded into one or more standardized rules 18 that are applied by a rule engine 12. The standardized rules 18 are provided to the rule engine 12 from the rule source 42. The rule source 42 may include a database (not depicted) populated with a plurality of standardized rules 18, or may be presented in a paper or online format and the standardized rules 18 are programmed by a clinician or computer technician to a rules database (not depicted) in communication with the rule engine 12 such that the standardized rules 18 may be applied by the rule engine 12. The rule source 42 may also include one or more research institutions or medical care facilities that are engaged in medical research, and may develop standardized rules 18.

The rule engine 12 is further communicatively connected to a local EMR database 44. The local EMR database 44 is populated with the electronic medical records of the local patients treated by the medical institution. The local EMR database 44 provides the medical data 16 from the electronic medical record of a patient to the rule engine 12. The same or some of the medical data may be de-identified as de-identified medical data 26 and used as part of a local outcome report 24. The local outcome report 24, or reports may provide the outcomes of a plurality of patients with varying, or similar, medical conditions.

De-identified medical data 46 is also transmitted to another EMR database 48. The EMR database 48 may be a database of regional, national, or international scope, such that the de-identified medical data from a plurality of local EMR databases is provided to populate the EMR database 48. The medical data from the EMR database 48 is used to create at least one general outcome report 50. Similar to the EMR database 48 from where the medical data came, the at least one outcome report 50 is regional, national, or international in scope. Allows for a statistical analysis of the incidences of diagnosed outcomes from patients with specific characteristics in their medical data. Across the entire regional, national, or international population.

At least one outcome report 30 of the at least one outcome report 50 is transmitted to the difference engine 28 wherein the outcome report 30 is compared to the outcome report 24 in a localization loop 22. The operation of the difference engine 28 and the localization loop 22 are described in further detail above with respect to FIG. 1.

The adaptive decision support system 40 differs from that depicted in FIG. 1 in that the adaptive decision support system 40 further includes a personalization loop 52. The personalization loop 52 makes use of the at least one general outcome report 50 which incorporates the de-identified local medical data aggregated into a larger pool of regional, national, or international medical data from which the at least one general outcome report 50 is derived. The at least one general outcome report 50 may be used by the rule source 42 to improve the standardized rules 18 developed by the rule source 42 or to create new standardized rates 18 applicable to the regional, national, or international population. Data analysis techniques may be applied to the at least one general outcome report 50 such as to produce clinical rules that focus on the nuances between patients that exhibit different medical characteristics such as differing body weights, ethnicity, gender, or pre-existing or chronic diseases. All of these personal medical characteristics may affect the prescribed treatment 20 from the application of these rules and thus the standardized rules 18 need to be modified to reflect these nuances. These nuances may be identified and developed into standardized rules 18 through the use of meta-studies, data mining techniques, and/or retrospective studies of the at least one general outcome report 50. The results of this analysis may lead to the development of new, and more specific, regional, national or international guidelines, which then may be encoded into standardized rules 18.

A few examples of the personalization of the standardized rules 18 that may occur due to increased analysis of the at least one general outcome report 50 include modifying the standardized rules to prescribe treatments that are better suited to patients with chronic diseases such as diabetes. In other instances, the standardized rules 18 may be modified to prescribe alternative courses of treatment for a bariatric patient. One such example of an alternative prescribed treatment for a bariatric patient, can include modifying the drug dosage levels, since the increased body size of the patient results in altered metabolism of the drugs prescribed to the patient.

Another example of a personalized modification to the standardized rules 18 includes identifying certain risks and/or characteristics of patients of differing ethnic backgrounds. Such nuances related to a patient's ethnic background may include changes to the prescribed treatment, as some drugs have been found to be more effective in certain ethnic populations than others. Alternatively, patients of some ethnic backgrounds have differing risks of certain diseases, or may exhibit differing normal, or baseline physiological measurements. One such example of this is that studies have found patients of Southeast Asian descent on average have lower triglyceride levels in a healthy patient. The standardized rules 18 may be modified to reflect this nuance, which results in a modified prescribed treatment when the rule engine 12 applies these standardized rules to the patient's medical data 16.

Alternatively, it has been suggested that some populations are less responsive to particular courses of treatment. The decreased responsiveness to treatment could be from an aversion to drug-based treatments, or a preference towards alternative treatments, including nutritional or lifestyle changes. Through an analysis of the outcome reports, these aversions or preferences can be identified and incorporated into the standardized rules 18. This may result in a prescribed treatment 20 that is likely to be more effective for the patient.

Thus, in the personalization loop 52, the large data set in the at least one general outcome report 50 can help to create standardized rules that are reflective of nuances in the physiology or treatment of particular groups of patients. A further advantage of this system is that a local doctor may be unfamiliar in treating a patient outside of the normal population demographics of the local area. In these instances, standardized rules that are nuanced to reflect these slight differences in diagnosis and treatment may be of an advantage to this doctor in treating an ever changing population.

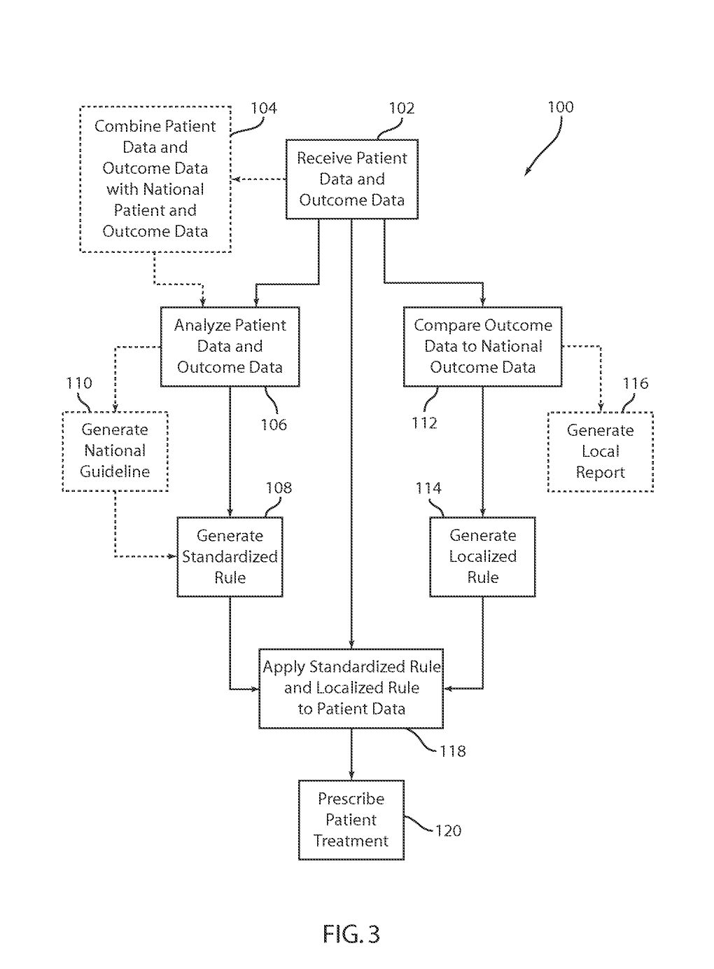

FIG. 3 is a flow chart depicting the steps of an embodiment of a method for providing adaptive decision support 100. First, in step 102, patient data and outcome data is received. The patient data and outcome data may be de-identified, such that there is no identifying patient information contained within the patient data and outcome data in accordance with HIPAA, and other medical information standards. The patient data typically includes patient physiological data such as laboratory and/or other diagnostic test results, patient medical history information, or other measures of patient condition. The outcome data may incorporate some or all of the patient data, but also includes information identifying the resulting diagnosis, treatment, and outcome associated with patient data. Next, in step 106, the patient data and outcome data are analyzed to determine any correlations between any of the patient data and the outcome data. In one embodiment, an additional step, step 104 may be included wherein the patient data and the outcome data are combined with regional, national or international patient and outcome data in order to form a single pool for analysis in step 106 that is reflective of patient data and outcome data across a region, country, or internationally.

The analysis of the patient data and outcome data performed in step 106 leads to generating at least one standardized rule in step 108. The standardized rule, or a plurality of standardized rules, generated in step 108 may be algorithm, or other logical arrangement that defines any identified correlations between the patient data and the outcome data in step 106. The step of generating at least one standardized rule in step 108 may further include the encoding of the rule into a computer readable format.

In an alternative embodiment, the additional step of generating a national guideline, step 110, is performed before generating at least one standardized rule in step 108. The generated national guideline from alternative step 110 may identify and present a correlation found in the analysis of the patient data and outcome data of step 106. The national guideline may be a textual statement of the identified correlation and may include a preferred treatment recommendation associated with the identified correlated patient data and outcome data.

The standardized rule generated in step 108 identifies the most likely risks and/or conditions that may be present in a patient exhibiting the patient data. The generated standardized rule typically includes a prescribed treatment that may be based upon the analyzed outcome data or the generated national guideline.

The method 100 may also, concurrent to the performance of steps 104-110, provide localization analysis in steps 112 and 114. In step 112, the received outcome data is compared to the national outcome data. The comparison of the received outcome data to the national outcome data helps to identify any areas of divergence wherein the localized risk of a medical condition is elevated in comparison to the level of risk for a medical condition nationally. This can help to identify localized pockets of increased risk for a medical condition, which may result in the generation of a local rule in step 114. The local rule generated in step 114 may be an algorithmic, or logical definition of the areas of divergence between the outcome data and the national outcome data compared in step 112. It should be noted that the national outcome data may alternatively be regional or international outcome data, such that the localization is performed with respect to regional, national, or international standards.

In an alternative embodiment, any divergences identified in the comparison of the outcome data to the national outcome data in step 112 is used in optional step 116 to generate a local report. The local report may be generated by presenting it on a graphical display, or may be a paper or electronic textual based report. The local report generated in step 116 identifies the areas and/or medical conditions in which the local population deviates from the national population. A local report that identifies such divergences provides a system of warning for clinicians in a localized area to identify both outbreaks of rare or unlikely diseases, as well as provide assistance in identifying localized environmental problems that may adversely affect the health of the general population health.

Next, at step 118, the standardized rule generated in step 108 and the localized rule generated in step 114 are applied to the patient data received in step 102. In step 118, the application of the standardized rule and the localized rule to the patient's data includes the application of the algorithms and/or logical statements that comprise each of the rules to the received patient data. The application of the standardized rule and the localized rule to the patient's data in step 118 produces a prescribed patient treatment in step 120. The prescribed patient treatment produced in step 120 includes a suggestion of a diagnosis of a patient's condition coupled with a suggested treatment regimen, which may include drugs, physical therapy, nutrition, or surgical treatments. The prescribed treatments are specifically tailored to include those treatments deemed to be most effective based upon some or all of the patient data to which this standard rule and local rules were applied. Thus, the prescribed patient treatment in step 120 may include variances based upon the demographics of the patient, or may provide different prescribed treatments, specific to the local area or region of that particular patient.

The presently disclosed system and method provide distinct advantages over other systems and methods for decision support. Embodiments of the disclosed system and method provide the advantages of being localized to factors or conditions that may afflict a certain geographical population. This may present an advantage in a situation wherein the patient is traveling, or is being treated in a medical facility that is remote from the patient's normal geographical location. In this situation the clinician treating the patient may not be aware of risks and/or conditions, yet the system may identify such localized rules. In another embodiment, the system and method as disclosed herein may provide personalized decision support, in that the medical data from patients in a large geographical region may be analyzed in order to define the rules for the decision support to reflect nuances in medical risk and treatment that are specific to particular patient demographic or local populations. These nuances may include the effectiveness of certain types of prescribed treatments or increased or decreased risks to particular diseases or pathologies.

It should be noted that in some embodiments of the system and method as disclosed herein the system and/or method may be performed solely through the use of a computer. In such embodiments the elements of the system and/or method may be comprised or carried out by one or more programs, or program components or modules that are carried out by a microprocessor of the computer in order to perform the described function or represent the describe system element. The technical effect of such embodiments is to provide a clinician with improved localized and/or personalized adaptive decision support.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent elements with insubstantial differences form the literal languages of the claims.

What is claimed is:

1. A system for providing locally adaptive decision support, the system comprising:
a database comprising a patient electronic medical record;
a local outcome report that documents an outcome associated with the patient electronic medical record;
a difference engine that receives the local outcome report and compares the local outcome report to a national outcome report, the difference engine identifying a divergence between the local outcome report and the national outcome report, and generating a localized rule, the localized rule reflecting the identified divergence; and
a rule engine that receives the patient electronic medical record from the database and receives the localized rule from the difference engine, the rule engine applying a standardized rule and the localized rule to the patient electronic medical record to produce a prescribed treatment.

2. The system of claim 1 further comprising a local report generator, wherein the difference engine produces an indication of the identified divergence and the local report generator receives the indication of the identified divergence and generates a report comprising the identified divergence.

3. The system of claim 2 wherein the local report generator comprises a graphical display and the local report generator causes the report to be presented on the graphical display.

4. The system of claim 1 wherein the database comprises a plurality of patient electronic medical records and the rules engine applies the localized rule and the standardized rule to each of the plurality of patient electronic medical records to produce a plurality of prescribed treatments.

5. The system of claim 4 comprising a plurality of local outcome reports, each one of the local outcome reports associated with one of the patient electronic medical records of the plurality of patient electronic medical records, the difference engine receiving the plurality of local outcome reports, identifying a plurality of divergences between the plurality of local outcome reports and the national outcome report, and generating at least one localized rule reflecting the plurality of identified divergences.

6. The system of claim 1 wherein the national outcome report identifies an average patient outcome and the identified divergence is a divergence in the outcome of the local outcome report and the average outcome of the national outcome report.

7. The system of claim 6 wherein the national outcome report is derived at least in part from the patient electronic medical record and the local outcome report.

8. The system of claim 1 wherein the patient electronic medical record and the local outcome report both comprise identifying information and before the national outcome report is derived from the patient electronic medical record and the local outcome report, any identifying patient information is removed from the patient electronic medical record and the local outcome report.

9. The system of claim 8 further comprising a rule source comprising a the standardized rule, the rules engine receiving the standardized rule from the rule source.

10. The system of claim 9 wherein the national outcome report is analyzed by the rule source to derive a new standardized rule, the new standardized rule being stored in the rule source.

11. A system for providing adaptive decision support, the system comprising:
a database comprising a patient electronic medical record;
a general outcome report identifying an average outcome;
a local outcome report that documents an outcome associated with the patient electronic medical record;
a difference engine that receives the local outcome report and compares it to the general outcome report, the difference engine identifying a divergence between the local outcome report and the general outcome report, and generating a localized rule, the localized rule reflecting the identified divergence;
a rule source comprising a standardized rule;
a rules engine that receives the patient electronic medical record from the database, receives the localized rule from the difference engine, and receives the standardized rule from the rule source, the rules engine applying the standardized rule and the localized rule to the patient electronic medical record to produce a prescribed treatment.

12. The system of claim 11 wherein the general outcome report is derived at least in part from the patient electronic medical record and the local outcome report.

13. The system of claim 12 wherein the patient electronic medical record and the local outcome report both comprise identifying information and before the general outcome report is derived, any identifying information is removed from the patient electronic medical record and the local outcome report.

14. The system of claim 13 further wherein the rule source receives the general outcome report the general outcome report including a plurality of patient electronic medical records and associated local outcome reports, and the rule source analyzes the general outcome report to identify a correlation between the patient electronic medical records and the local outcome reports of the general outcome report.

15. The system of claim 14 wherein the plurality of patient electronic medical records each comprise demographic information and the rate source identifies a correlation between the demographic information and the local outcome.

16. The system of claim 15 wherein the rule source produces a standardized rule based on the identified correlation.

17. A method of providing adaptive decision support, the method comprising the steps of:
receiving local patient data and local outcome data;
comparing the local outcome data to national outcome data;
generating a localized rule from the comparison of the local outcome data to the national outcome data;
analyzing the local patient data and the local outcome data;
generating a standardized rule from the analysis of the local patient data and the local outcome data;
applying the standardized rule and the localized rule to the local patient data;
generating a prescribed treatment.

18. The method of claim 17, further comprising the step of combining the local patient data and the local outcome data with national patient data and the national outcome data to produce combined patient data and combined outcome data wherein the combined patient data and the combined outcome data is analyzed and the standardized rule is generated from the analyzed combined patient data and the combined outcome data.

19. The method of claim 18 further comprising the step of generating a national guideline from the analysis of the combined patient data and the combined outcome data, the standardized rule being generated from the national guideline.

20. The method of claim 17 further comprising the step of generating a local report from the comparison of the local outcome data to the national outcome data.
